(19) United States
(12) Patent Application Publication
(10) Pub. No.: US 2019/0195623 A1
(43) Pub. Date: Jun. 27, 2019

(54) METHOD FOR DETECTING THE DIRECTION OF ORIENTATION OF A VEHICLE AND USE OF THE METHOD

(71) Applicant: DÜRR Assembly Products GmbH, Püttlingen (DE)

(72) Inventors: Andrè DEUTSCH, Herbitzheim (FR); Michel LECOMTE, Hunting (FR)

(73) Assignee: DÜRR Assembly Products GmbH, Püttlingen (DE)

(21) Appl. No.: 16/301,302

(22) PCT Filed: May 12, 2017
(86) PCT No.: PCT/DE2017/100406

§ 371 Date: Nov. 13, 2018

(30) Foreign Application Priority Data
May 13, 2016 (DE) 10 2016 108 973.7

(51) Int. Cl. G01B 11/27; G06T 7/73

(52) U.S. Cl. CPC G01B 11/272; G06T 2207/30252; G06T 7/74

(57) ABSTRACT

The present invention relates to a method for detecting the direction of the orientation of a vehicle, wherein the direction of the orientation of the vehicle is the direction of the axis of symmetry of the vehicle. In this case, the currently imaged vehicle represents its own reference in that, from the photographic image of the front side of the vehicle, a correlation is determined between the parts of the photographic image of the front side of the vehicle that are located in different parts of the photographic image of the front side of the vehicle with respect to an optical axis of symmetry of the front side of the vehicle, wherein the direction of the orientation of the vehicle relative to the imaging direction of the photographic image is derived from the correlation. The detected direction of the orientation of the vehicle can be used in test procedures of vehicle units, which, in terms of the radiation and/or reception direction of beams are to be aligned with the direction of the orientation of the vehicle or its geometrical axis of travel. The evaluation can be effected both with a photographic image of the front side of the vehicle, as well as also with a photographic image of the rear side of the vehicle.

### PRIOR APPLICATIONS

This application claims priority to and all advantages of PCT/DE2016/100406, filed May 12, 2017 and German Patent Application No. DE 102016108973.7, filed May 13, 2016, the content of which is hereby incorporated by reference.

### TECHNICAL FIELD

The present invention relates to a method according to the preamble of claim 1. Here, the direction of the orientation of the vehicle is the direction of the axis of symmetry of the vehicle body. Furthermore, the invention relates to a use of the method according to one of claims 3, 4, or 5.

### BACKGROUND

For example, for the test of the radiation direction of the headlights of a motor vehicle, it is known to use a testing device, which is capable of determining the radiation direction of the headlights with respect to a defined axis of the testing device. This defined axis of the testing device extends in the horizontal plane. The testing device is displaced in the lateral direction, in front of the vehicle, in order to test and, as the case may be, adjust the right and left headlights. In order to conduct the test procedures, it is necessary that the vehicle and the testing device are aligned to one another in such a way that the longitudinal direction of the vehicle (i.e. the axis of symmetry of the vehicle, which, in the head light adjustment, is the direction of the orientation of the vehicle in the context of the present patent application) is parallel to the defined axis of the testing device. In order to be able to align the vehicle and the testing device to one another in this way, the testing device emits a calibrated laser beam which—in the horizontal plane—extends perpendicularly to the defined axis of the testing device. The testing device can be positioned in front of the vehicle headlight to be tested and be rotated around the vertical axis in such a way that the laser beam intersects two points of the vehicle body, which are located on the left and on the right vehicle side. These two points can, for example, be the corners of the vehicle hood at the transition of the front edge of the hood to the right-side edge of the hood, on the one hand, and to the left side edge of the hood, on the other hand. In the case that the testing device is oriented accordingly, by a rotation around the vertical axis, the defined axis of the testing device extends parallel to the symmetrical longitudinal axis of the vehicle body. Subsequently, the headlights are tested and can be adjusted, as required.

The object underlying the present invention is to simplify the detection of the direction of the orientation of a vehicle relative to a defined direction of a testing device for vehicle units.

### SUMMARY

According to the invention, this object is achieved in accordance with claim 1. Here, from a photographic image of the front side and/or of the rear side of the vehicle, a correlation is determined between the parts of the photographic image of the front side or of the rear side of the vehicle that are located in different parts of the photographic image of the front side or of the rear side of the vehicle with respect to an optical axis of symmetry of the front side or of the rear side of the vehicle. The direction of the orientation of the vehicle relative to the imaging direction of the photographic image is derived from the said correlation.

In this case, the simplest way is that the imaging direction of the camera corresponds to the target value of the direction of the orientation of the vehicle. In this case, a “conversion” of the image is not required. Such a conversion would be necessary if the imaging direction of the camera would extend obliquely to the target value of the direction of the orientation of the vehicle.

The term “imaging direction” relates to the central axis of the solid angle of the respectively captured image.

Vehicles usually have a symmetry in relation to a vertical section in the center of the vehicle body in the longitudinal direction of the vehicle body. Examples for some “interfering,” elements of the vehicle, in this symmetry, are listed in conjunction with claim 2.

If the direction of the orientation of the vehicle, in the photographic image, corresponds to the target value of the direction of the vehicle, the correlation of the two parts of the photographic image of the front side as well as of the rear side is greater than in a vehicle, the direction of the orientation of which is oblique to the imaging direction of the camera. Thus, the direction of the orientation of the vehicle can be derived from the factor of the correlation.

The correlation in turn can be derived in that that the two parts of the photographic image are considered as planes in the photographic image. Just as well, it is possible to evaluate characteristic points or lines in the photographic image in their position and orientation to one another, in order to determine the correlation.

The image of the front side is evaluated separately, which is also true for the image of the rear side. A combination can be effected in that after the separate evaluation of the photographic image of the rear side, a mean value is established for the orientation of the vehicle.

Due to the fact that the front view of a vehicle visually differs from the rear view, a correlation of a front view with a rear view would not yield any reasonable results.

It is furthermore possible, via a purely-qualitative assessment of whether the orientation of the vehicle corresponds to a target value for the orientation, to determine the amount of deviation of the direction of the orientation of the vehicle with respect to the target value for the orientation of the vehicle.

By a controlled rotation of the camera with the photographic image by known angles, the maximum value of the correlation can be determined depending on the rotational angle of the camera. In the maximum of the correlation, the direction of orientation of the vehicle can be determined from the rotational angle of the camera in the photographic image in relation to an initial direction of the camera prior to the rotation (target direction of the camera).

In addition to this metrological detection via an angle of rotation of the camera in a maximum value of the correlation, it is also possible to evaluate the photographic image without a rotation of the camera. The location of characteristic lines in the two parts of the image to be compared, can be compared in order to determine the correlation therefrom.

In order to have defined conditions in the photographic image, the camera can be attached to a so-called gantry in the area of a testing device. This gantry is constituted by an arc to which various testing devices can be fastened. It is then possible to determine the orientation of the vehicle relative to the gantry.

In the embodiment of the method according to claim 2, certain parts of the photographic image are weighted weaker than other parts of the photographic image in the determining of the correlation in the method according to claim 1.

This different weighting can also consist in that certain regions of the photographic image remain completely unconsidered in the evaluation.

This has proven to be advantageous in as far as that in the symmetrical observation of the vehicle with respect to the vertical central plane of the vehicle in the longitudinal direction thereof, some elements are contained which, in the observation of the two parts, are asymmetric. It has proven to be advantageous to weight those parts of the photographic image, that contain these elements, weaker or to completely dispense with them.

A first example is that the emblems of some automotive manufacturers are asymmetric with respect to a mirror-imaging about a vertical center axis. In the region in which the emblems of the automotive manufacturers are attached and visible in the front region as well as in the rear region, the correlation in the two parts of the photographic image is reduced due to this asymmetry.

Other examples include asymmetries which may be caused by manufacturing tolerances. These can be different clearances, for example between the hood or the tailgate or the trunk lid, and the respective fender, from the left side of the vehicle and the right side of the vehicle.

Further systematic asymmetries can e.g. be caused by the following elements:

By the windshield wipers of the vehicle.
These are—irrespective of being in the resting position or the operating position—asymmetric in any respect to the central plane of the vehicle in the longitudinal direction thereof. By contrast, a symmetric arrangement can be found in a single blade system arranged in the center, if the wiper is in the perpendicular position. In the wiping process and in the resting position, this wiper likewise constitutes an asymmetry, reducing the correlation if the wiper arm is visible in the photographic image. This concerns both the front view and the rear view of a vehicle.

By engravings in the windshield or the rear window.
Obviously, these engravings are only of importance if digitized in the photographic image. This concerns both the front view and the rear view of a vehicle.

By the different shapes and dimensions of exterior mirrors on the left and on the right.
The exterior mirror on the left is usually larger than the exterior mirror on the right. This concerns both the front view and the rear view of a vehicle.

By an alignment of the rearview mirror in the interior of the vehicle.
Due to the said adoption of the driving mirror (rearview mirror) to the driver, likewise an asymmetry results in relation to the central plane of the vehicle in the longitudinal direction thereof. This mainly concerns the front view of the vehicle, because in a rear view the interior mirror is only indistinctly discernable—if that.

By the sun visors of the vehicle, which may be lowered on one side only. This mainly concerns the front view of a vehicle, because in a rear view, a lowered sun visor is—if that—only indistinctly discernable.

By the steering wheel of the vehicle.
The steering wheel is located only on one side of the vehicle, so that this causes an asymmetry with respect to the vertical central plane of the vehicle in its longitudinal direction in a view on to the vehicle from the front. This mainly concerns the front view of a vehicle, because in a rear view, the steering wheel is—if that—only indistinctly discernable.

Due to an asymmetric design of the dash panel.
Such an asymmetric design is, for example, caused in that there is an upward bulging located on the side of the driver, in order to accommodate the display elements in the instrument cluster. Such a bulging can also be visible in a view on to the vehicle from the front. This mainly concerns the front view of a vehicle, because in the rear view, the dash panel is—if that—only indistinctly discernable.

Due to a license plate of the vehicle.
A license plate is neither mirror-symmetrical with respect to a vertical central plane of the vehicle in the longitudinal direction of the vehicle. This concerns both the view from the front and the view from the rear of the vehicle. However, this effect plays no role in a vehicle which is to be tested at the end of the manufacturing belt, because in this case, the license plates are not yet mounted.

Due to an exhaust pipe.
The exhaust pipe can be located offset to the central plane asymmetrically only on one side of the vehicle. This concerns the view from the rear of the vehicle. Practically, this only concerns the view from the rear of the vehicle, because the exhaust pipe is not discernable in a view from the front.

It is possible to hide such regions and to leave them unconsidered upon image evaluation. This also reveals that a large part of the described elements that cause asymmetries are arranged above a horizontal line which represents the upper edge of the hood. If the area of the photographic image to be evaluated is, right from the start, limited to the image detail below this upper edge of the hood (as the case may be, also to the region of the front side to the height of the radiator grille), a post-processing of the photographic image can largely by prevented by hiding the mentioned regions, because these elements are no longer located in the part to be evaluated of the photographic image anyway.

In this case, one should be aware of that these regions—e.g. in terms of the extension of the gap between the hood and the right and left fenders—can at the same time constitute a characteristic line for the determination of the correlation of the two parts of the photographic image. It can therefore be useful, instead of a weaker weighting, to provide a post-processing of the photographic image such that a black line with a uniform thickness according to the course of the center line of the gap between the hood and the right and left fenders is superimposed on the image of the respective gap. This counteracts the effect of the negative impact of different gap widths on to the correlation. Advantageously, the course of the respective gap can be taken into consideration.

Claim 3 relates to the use of the method according to one of the preceding claims, for the control or regulation of the orientation of a testing device for vehicle units for performing a test procedure, or for performing a testing and adjustment procedure. The testing device has a defined direction such that using the testing device during a test procedure, or during the testing and adjustment procedure, the radiation and/or reception direction of at least one vehicle unit is tested as to whether this radiation and/or reception direction matches the defined direction of the testing device. In this case, the testing device is oriented, prior to the performing of the test procedure, in such a way that the defined direction of the testing device is aligned with respect to the direction of the orientation of the vehicle.

The testing device can be a testing device according to the type described above for the radiation direction of headlamps. The headlamps are adjusted relative to the axis of symmetry of the vehicle body.

The device can also be a testing device testing the radiation direction or reception direction of sensors used for the so-called ACC systems (Automatic Cruise Control). These sensors are adjusted to the geometric axis of travel of the vehicle. In an optimally-adjusted vehicle, the axis of symmetry and the geometric axis of travel coincide. If a remaining deviation between the geometric axis of travel and the axis of symmetry is known, this deviation can be considered in that the orientation of the geometric axis of travel is calculated on the basis of the vehicle's orientation in view of the axis of symmetry of the vehicle body.

In any case, it is possible to make a preset of the sensors for the ACC systems, in that these are adjusted to the axis of symmetry of the vehicle body. The exact adjustment can be performed in a subsequent working step then.

It is described in the context of this patent application that the direction of orientation of the vehicle (vehicle axis of symmetry) refers to the direction of the vehicle body. The described units of the vehicle (i.e. the ACC sensors) are not directly aligned with the longitudinal direction of the body of the vehicle, but to the geometric axis of travel of the vehicle. The geometric axis of travel of the vehicle corresponds to the bisecting line of the lane angles of the wheels of the rear axle of the vehicle. In optimally-adjusted values of the parameters of the chassis geometry, the geometric driving axis of the vehicle coincides with the axis of symmetry of the vehicle body. Nevertheless, there are tolerances in the adjusting of the parameters of the chassis geometry as well as manufacturing tolerances in the production of the body. This is why the geometric driving axis can deviate from the axis of symmetry of the vehicle body. In setting the parameters of the chassis geometry, a deviation of the geometric driving axis to the axis of symmetry of the vehicle is identified and detected. In this way, it is also possible to align the testing device to the direction of orientation of the vehicle in the context of a vehicle body, so that the “offset” of the difference of the geometric driving axis of the vehicle relative to the axis of symmetry of the vehicle body is considered. The orientation of the testing device “with respect to the orientation of the vehicle” thereby explicitly also includes a configuration in which the testing device is being aligned to the geometric driving axis of the vehicle.

After alignment the testing device, a test of the units of the vehicle can be performed, as to whether the radiation and/or reception direction thereof is located in the straight-forward direction. In this case, it depends upon the performed alignment of the testing device whether this test is effected with respect to the axis of symmetry of the vehicle body, or with respect to the geometric driving axis of the vehicle.

In a test, it is merely checked if the respective unit is aligned properly. In a testing and adjustment procedure, the testing device is used to directly communicate a feedback, while performing the adjustment works on the unit, as to whether the adjustment of the unit is within the tolerance range.

Claim 4 relates to the use of the method according to one of claims 1 or 2 for testing the radiation and/or reception direction of at least one unit relative to the orientation of the vehicle with a testing device. The testing device has a defined direction in such a way that during the test procedure, the radiation and/or reception direction of at least one vehicle unit is tested with the testing device as to whether this radiation and/or reception direction matches the defined direction of the testing device. During the test procedure, the testing device is being oriented into such an orientation position that the radiation and/or reception direction of the at least one vehicle unit in this orientation position of the testing device matches the defined direction of the testing device. The radiation and/or reception direction of the at least one unit relative to the direction of the orientation of the vehicle is derived from the detected direction of the orientation of the vehicle and the orientation position of the testing device.

In the use of the method according to claim 4, the object is to test as to whether the radiation and/or reception direction of the vehicle unit is adjusted correctly. To this end, the radiation and/or reception direction of the vehicle unit is aligned. Subsequently, an assessment is made as to how far the testing device had been rotated in order to be aligned to the actual radiation and/or reception direction of the unit. By considering the identified direction of the orientation of the vehicle, it can be identified from the orientation position of the testing device, whether the radiation and/or reception direction of the vehicle unit is correctly adjusted with respect to the orientation of the vehicle.

Compared to the described relationships in conjunction with claim 3, it is also possible to assess whether the radiation and/or reception direction of the unit of the vehicle is correctly adjusted with respect to the geometric driving axis of the vehicle.

In the configuration according to FIG. 4 it can be identified whether the respective unit of the vehicle is adjusted correctly or not. It is thereby also possible to assess the magnitude of a possibly-existing incorrect adjustment. In this case, a parameter can be output to correct the adjustment. When performing the correction, the testing device can be re-adjusted in its orientation position, in order to thereby check whether the setting of the respective unit is correct or not.

Claim 5 relates to the use of the method according to one of claims 1 or 2 for deriving a corrective value upon the assessment of test results when performing test work for vehicle units by means of a testing device.

The testing device has a defined direction such that, by means of the testing device and during the testing procedure, the radiation and/or reception direction of at least one unit of the vehicle is tested as to whether this radiation and/or radiation direction coincides with the defined direction of the testing device. The testing device is constantly aligned in such a way that the defined direction of the testing device is constant in as far as this direction, along with a displacement of the testing device, is displaceable in parallel, if that. The corrective value is determined depending on the deviation of the identified direction of the orientation of the vehicle relative to the defined direction of the testing device.

In this configuration, it has proven to be advantageous that a mechanical readjustment is not required. Performing the test work—possibly together with adjustment works—occurs in that the measurements are made by means of the testing device, and the radiation and/or reception direction of the respective unit is identified in relation the defined direction of the testing device. The evaluation as to whether the radiation and/or reception direction is within the allowed tolerance limits is made by considering the corrective value.

Here, the evaluation can likewise be made in relation to the geometric driving axis of the vehicle, according to the explanation in conjunction with claim 3.

The procedure according to the present invention, according to which the orientation of the vehicle is determined exclusively by means of a captured image of a vehicle, has advantages compared to known methods, in other known methods, first a reference image of an identical vehicle with a defined orientation is captured. From a comparison of an image of a vehicle with the reference image, the orientation of the vehicle is subsequently compared relatively to the defined orientation of the identical vehicle in a reference image. In this procedure, only those vehicles can be measured for which a reference image is provided. This is also true if vehicles of an identical vehicle type are optically different. This can e.g. be due to that one vehicle type has a sport suspension as optional equipment. The visual appearance of such a vehicle differs from that of a series vehicle, because in the photographic image, the visual size of the wheels or the height position of the vehicle are different. Other deviations can be caused by fog lights as optional equipment, by ventilation slits for a vehicle with supercharger or the like.

### BRIEF DESCRIPTION OF THE DRAWINGS

One exemplary embodiment of the invention is illustrated in the drawing. Shown are in:

FIG. 1: a photographic image of a vehicle in a front view,

FIG. 2: a photographic image of another vehicle in a front view, and

FIG. 3: a gantry system for measuring the orientation of a vehicle.

### DETAILED DESCRIPTION

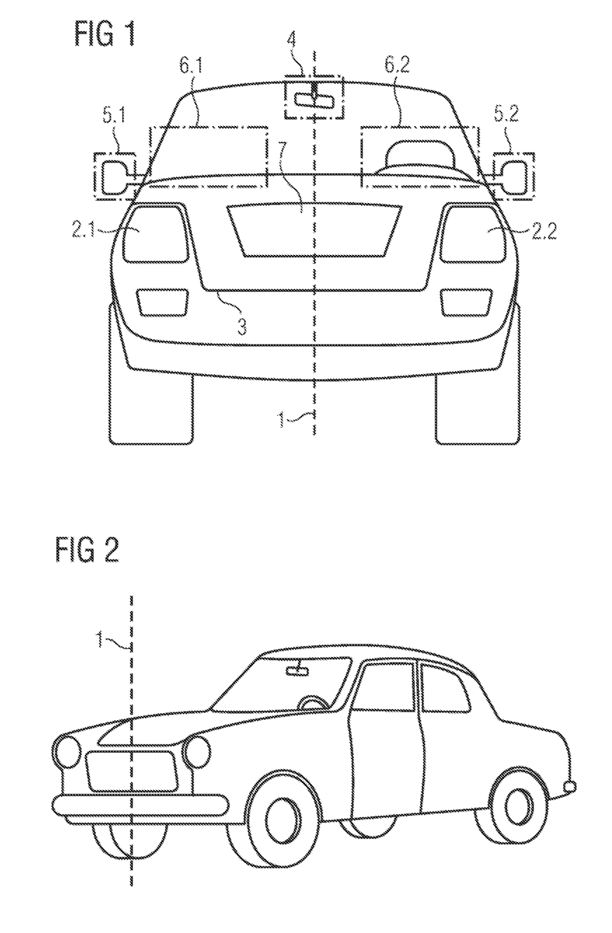

FIG. 1 shows a photographic image of a vehicle in a view from the front.

A symmetrical plane 1 is illustrated as a dotted line. This symmetrical plane is represented by the illustrated line. The symmetrical plane results as a plane which is oriented parallel to the imaging direction of the camera or in which the imaging direction of the camera is located within said axis of symmetry. In addition, the dashed-dotted vertical center line of the vehicle (dashed-dotted line with the reference character 1 of FIG. 1) is in said symmetrical plane.

According to the present invention, the part left-hand from the vertical symmetrical plane 1 of the vehicle in the photographic image correlates with the part right-hand from the vertical symmetrical plane 1 of the vehicle 1 in the photographic image.

The correlation of a vehicle, the orientation of which is straight, is e.g. determined by means of position and shape of the headlamps 2.1 and 2.2 with respect to a mirror-symmetrical arrangement to the symmetrical plane 1. Further elements causing the correlation are lines running mirror-symmetrically to the symmetrical plane 1. This is e.g. the case with line 3, representing the edge of the hood, or with the edge line 7 of the radiator grille.

Furthermore, in the illustration of FIG. 1, parts 4, 5.1, 5.2 and 6.1 and 6.2 of the photographic images are marked in dashed-dotted lines, which are not mirror-symmetrical to the symmetrical plane 1, even if the orientation of the vehicle is straight.

The interior mirror of the vehicle is located in part 4 of the photographic image. This mirror is adapted to the seating position of the driver. Due to the rotation of the interior mirror, said mirror is no longer symmetric to the symmetrical plane 1.

In the two parts 5.1. and 5.2, the exterior mirrors are located on the right or on the left, respectively. These exterior mirrors often have different dimensions in vehicles, so that the two exterior mirrors in parts 5.1 and 5.2 of the photographic image are likewise non-symmetrical to the symmetrical plane 1.

In part 6.2 of the photographic image, a bulge of the dash panel upward to accommodate the instrument cluster and the steering wheel is located in part 6.2 of the photographic image. These elements are not present on the other side of the vehicle, so that these elements are likewise non-symmetrical to the symmetrical plane 1. This is why the part 6.2 of the photographic image is illustrated in dash-dotted lines as well. The respective part 6.1 of the photographic image on the other side of the vehicle is also illustrated in dash-dotted lines.

It is particularly advantageous if these dash-dotted parts of the photographic image are weighted weaker or are completely hidden when determining the correlation.

Other examples for such asymmetries are explained in conjunction with claim 2.

Apart from that, it can be seen that the photographic image of the vehicle reaches a maximum value of correlation in view of both parts to the left and to the right of the symmetrical plane 1, if the vehicle's orientation is straight. In conjunction with FIG. 1, this means that the orientation of the vehicle coincides with the imaging direction of the camera, if the imaging direction of the camera is oriented perpendicular to the plane of the drawing.

This maximum of correlation is also determined by means of other elements which are not separately denoted with reference characters in FIG. 1, such as e.g. the fog lights, the contour line of the bumper, the wheels of the vehicle and the outer contour of the vehicle.

For example, the correlation can be determined as a normalized value, in that one of the two parts of the photographic image to the left or to the right of the symmetrical plane is mirrored by way of calculation, and subsequently, the correlation between the non-mirrored part of the photographic image and the mirrored part of the photographic image is determined. Advantageously, this correlation is determined in a normalized manner, so that the value “1” corresponds to the maximum of the correlation. In a smaller correlation, it can be concluded that the vehicle's orientation is not straight.

The corresponding relations are illustrated for a different vehicle in FIG. 2. The symmetrical plane is also illustrated by the dashed line 1 there.

It can be taken from the illustration of FIG. 2 that the normalized correlation of the two parts of the photographic image to the left and to the right of the symmetrical plane 1 will yield a value of the correlation which is significantly smaller than “1”. This is also true in the case in which the parts illustrated in dash-dotted lines of the photographic image in FIG. 1 are hidden.

This is due to the fact that because of the “oblique” orientation of the vehicle in the photographic image (i.e. in the plane of the image) the symmetry around the symmetrical plane 1 is significantly reduced. By the oblique orientation of the vehicle, part of the vehicle is shifted to the right part of the photographic image to a great extent.

The illustration of FIG. 2 represents a significantly oblique orientation of the vehicle. However, the same effect also occurs if the orientation of the vehicle is less oblique. Not sooner than with a straight orientation of the vehicle, the maximum value of correlation is again achieved.

Besides a “shifting” of part of the vehicle into only one part of the photographic image, the perspective distortion of the image of the vehicle, in an oblique orientation of the vehicle, also reduces the correlation as a consequence of the oblique orientation of the vehicle.

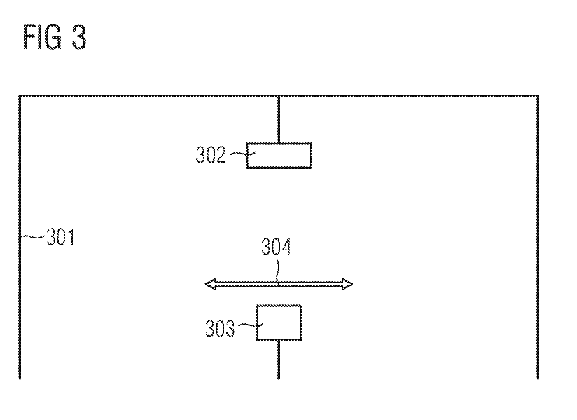

FIG. 3 shows a gantry system 301 for measuring the orientation of a vehicle. It can be seen that a camera 302 is attached to the gantry system 301. Advantageously, the imaging direction of the camera is oriented in such a way that the latter is perpendicular to the gantry system 301 and therefore also to the drawing plane.

Furthermore, a testing and measuring device 303 can be discerned, which, according to the directions of arrows 304, can be displaced to the left or to the right. Advantageously, such an arrangement according to the explanations in conjunction with claims 3 to 5 allows a measurement and orientation of vehicle units.

Accordingly (not explicitly illustrated here), camera 302 can also be laterally-displaceable. In accordance with the explanations of the position of the symmetrical axis in conjunction with FIG. 1, it becomes possible to laterally shift the camera 302 in such a way that the imaging direction of the camera 302 intersects the illustrated, dash-dotted line 1. It is also possible to maintain the camera 302 stationary, and to laterally-shift the captured photographic illustration of the vehicle, in a calculated or graphical manner by means of image post-processing, to the side until the then newly-resulting dash-dotted line “1” is located in the imaging direction of the camera.

The orientation of the vehicle can subsequently be determined in that the camera is rotated until a maximum correlation of the image halves results. The orientation of the vehicle relative to a desired value of orientation corresponds to the angle, by which the camera had been rotated until the maximum of the correlation was achieved.

As an alternative to the rotation of the camera, the latter can also remain stationary-fixed, wherein in this case, the photographic image is rotated by means of computing or by means of graphics until the maximum correlation is achieved. In this case, the “angle” of this computational or graphical rotation of the photographic image corresponds to the deviation of the orientation of the vehicle from a desired value of the orientation.

The testing and measuring device 303 can also be displaced laterally as far as until the opening below the gantry becomes accessible, so that a vehicle can drive through below the gantry. This is advantageous in testing work on vehicles, because in this case, one vehicle can exit the testing position and at the same time, another vehicle can enter the testing position.

In the illustrations of FIGS. 1 and 2, the vehicles are each illustrated from the perspective of a substantially horizontal imaging direction. It can be seen that the photographic image can also take place in that the vehicle is imaged obliquely from above.

1. Method for detecting the direction of the orientation of a vehicle, wherein the direction of the orientation of the vehicle is the direction of the axis of symmetry of the vehicle,
characterized in that a correlation is determined, from a photographic image of the front side and/or of the rear side of the vehicle, between the parts of the photographic image of the front side, or of the rear side of the vehicle, which are located in different parts of the photographic image of the front side or of the rear side of the vehicle with respect to an optical axis of symmetry (1) of the front side or the rear side of the vehicle, wherein the direction of the orientation of the vehicle relative to the imaging direction of the photographic image is derived from the correlation.

2. Method according to claim 1,
characterized in that certain parts (4; 5.1; 5.2; 6.1, 6.2) of the photographic image are weighted weaker than other parts of the photographic image in the determination of the correlation.

3. Use of the method according to one of the preceding claims, for the control or regulation of the orientation of a testing device for vehicle units for performing a test procedure, or for performing a testing and adjustment procedure, wherein the testing device (303) has a defined direction in such a way that using the testing device daring a test procedure, or during the testing and adjustment procedure, the radiation and/or reception direction of at least one vehicle unit is tested as to whether this radiation and/or reception direction matches the defined direction of the testing device (303), in that the testing device (303) is oriented, prior to the performing of the test procedure, in such a way that the defined direction of the testing device (303) is aligned with respect to the direction of the orientation of the vehicle.

4. Use of the method according to one of claims 1 to 3 for testing the radiation and/or reception direction of at least one unit relative to the direction of the orientation of the vehicle with a testing device, wherein the testing device (303) has a defined direction in such a way that during the test procedure, the radiation and/or reception direction of at least one vehicle unit is tested with the testing device (303) as to whether this radiation and/or reception direction matches the defined direction of the testing device (303), wherein, during the test procedure, the testing device (303) is oriented into such an orientation position, that the radiation and/or reception direction of the at least one vehicle unit in this orientation position of the testing device (303) matches the defined direction of the testing device (303), wherein the radiation and/or reception direction of the at least one unit relative to the direction of the orientation of the vehicle is derived from the detected direction of the orientation of the vehicle and the orientation position of the testing device (303).

5. Use of the method according to one of claims 1 to 3, to derive a corrective value in the evaluation of test results in the performing of test works for vehicle units by means of a testing device (303), which has a defined direction in such a way that, during the test procedure, the radiation and/or reception direction of at least one vehicle unit is tested with the testing device (303) as to whether this radiation and/or reception direction matches the defined direction of the testing device (303), wherein the testing device (303) is constantly oriented in such a way that the defined direction of the testing device (303) is constant in as far as that it is parallelly displaceable along with a displacement of the testing device (303), if need be, wherein the corrective value is determined dependent upon the deviation of the detected direction of the orientation of the vehicle with respect to the defined direction of the testing device (303).
